(19) United States
(12) Patent Application Publication
(10) Pub. No.: US 2004/0250716 A1
(43) Pub. Date: Dec. 16, 2004

(54) Stencil printer

(75) Inventors: Takayuki Onodera, Miyagi (JP); Daisuke Hasebe, Miyagi (JP); Kazuyoshi Kobayashi, Miyagi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Tohoku Ricoh Co., Ltd., Shibata-gun (JP)

(21) Appl. No.: 10/765,137

(22) Filed: Jan. 28, 2004

(30) Foreign Application Priority Data
Feb. 17, 2003 (JP) 2003-038595 (JP)

(51) Int. Cl. B41L 13/04

(52) U.S. Cl. 101/116

(57) ABSTRACT

A stencil printer of the present invention includes a print drum implemented as a porous hollow cylinder rotatably supported and configured such that a perforated stencil is wrapped therearound. A pressing device forms a pressing portion when pressed against the print drum. A feeding device feeds a sheet toward the pressing portion. A registration roller pair conveys the sheet toward said pressing portion at preselected timing. One roller of the registration roller pair expected to contact, when the sheet carrying an image on its one surface is reversed and again fed by said feeding device, the one surface first is provided with a highly oil-repellent surface configuration.

### BACKGROUND OF THE INVENTION

1. Field of the Invention

The present invention relates to a stencil printer for performing printing with a master or perforated stencil wrapped around a print drum.

2. Description of the Background Art

A thermal, digital stencil printer is conventional and includes a print drum. After a master or stencil selectively perforated by heat has been wrapped around the print drum, ink is fed from ink feeding means arranged inside of the print drum. In this condition, a press roller, press drum having substantially the same diameter as the print drum or similar pressing means continuously presses a sheet-like recording medium (sheet hereinafter) against the print drum. As a result, the ink is transferred to the sheet via the porous portion of the print drum and perforations formed in the master.

The print drum includes a porous support implemented as a hollow cylinder and a laminate of mesh screens formed of resin or implemented as wire nets and wrapped around the porous support. The stencil has a laminate structure made up of a thermoplastic resin film and a porous base formed of Japanese paper fibers or synthetic fibers or a mixture thereof and adhered to the resin film. While the film surface of the stencil is held in contact with heating devices arranged on the thermal head, the thermal head is operated in the main scanning direction. At the same time, the stencil is conveyed by a platen roller or similar conveying means in the subscanning direction. As a result, the stencil is selectively perforated, or cut, by the heat of the thermal head.

Today, duplex printing, i.e., printing images on both surfaces of a sheet is spreading for the purpose of saving sheets. As for ink applicable to the stencil printer, water-in-oil type of emulsion ink is predominant that does not dry on the printer so as not to stop up the print drum or the mesh screens, but dries when transferred to a sheet because its volume decreases due to the permeation of water and oil thereof into the sheet.

However, the stencil printer does not use solidification based on oxidative polymerization customary with offset ink or thermal fixation customary with, e.g., a copier. It follows that if a conveying member for conveying a sheet contacts the image surface of the sheet, then ink is transferred from the sheet to the conveying member and then transferred to the next sheet, resulting in offset.

Generally, a conveying member for conveying a sheet is implemented by a registration roller pair that conveys a sheet by nipping it. One of the registration roller pair is formed of rubber or elastic material while the other roller is formed of metal or resin. When such two rollers contact each other, the elastic roller deforms so as to make contact pressure uniform. This protects the sheet being conveyed from skew and creases ascribable to non-uniform contact pressure.

In a duplex print mode, the stencil printer turns a sheet, which carries an image on one surface thereof (simplex print hereinafter), and again conveys it or again feeds the simplex print after the print has been reversed. Such a procedure, however, has the following problem left unsolved. When the rubber roller contacts the image surface of a simplex print first, it is likely that ink is transferred from the print to the roller surface. When the rubber roller is positioned under the other roller, i.e., at the side opposite to an image surface and when a sheet is passed a plurality of times to form a composite image, the rubber roller does not contact the image surface or upper surface of the sheet and is therefore free from smearing ascribable to ink. However, when a simplex print is reversed and again conveyed, ink on the image surface is sometimes transferred to the rubber roller and then transferred to the next sheet, resulting in offset or so-called roller mark.

Although a simplex print may be left for a period of time long enough for oil to permeate into the print and dry before the second printing in order to solve the above problem, this scheme extends the printing time to thereby critically lower productivity.

A traditional stencil printer, rarely effecting duplex printing, can use rollers formed of nitril rubber, chloroprene rubber or similar ordinary rubber in consideration of a conveying force, wear and so forth. Today, however, the problem discussed above is serious due to duplex printing frequently used to save sheets. While Japanese Patent Laid-Open Publication No. 2001-139177, for example, proposes an improved rubber roller for conveying a sheet, such an improvement is directed toward accurate conveyance, but not toward the obviation of offset particular to duplex printing.

Technologies relating to the present invention are also disclosed in, e.g., Japanese Patent Laid-Open Publication Nos. 7-315618, 2001-58734 and 2001-139178.

### SUMMARY OF THE INVENTION

It is an object of the present invention to provide a stencil printer that causes a minimum of offset to occur even in a repeated duplex print mode operation for thereby enhancing efficient printing.

A stencil printer of the present invention includes a print drum comprising a porous hollow cylinder rotatably supported and configured such that a perforated stencil is wrapped around the outer periphery of the print drum. A pressing device forms a pressing portion when pressed against the print drum. A feeding device feeds a sheet-like recording medium toward the pressing portion. A plurality of conveying members convey the recording medium. One of the conveying members expected to contact, when the recording medium carrying an image on one surface thereof is reversed and again fed by the feeding means, the one surface first is provided with a highly oil-repellent surface configuration.

### BRIEF DESCRIPTION OF THE DRAWINGS

The above and other objects, features and advantages of the present invention will become more apparent from the following detailed description taken with the accompanying drawings in which:

FIG. 1 is a front view showing a stencil printer embodying the present invention;

FIG. 2 is an isometric view showing a registration roller pair included in the illustrative embodiment;

FIG. 3 is a front view showing a mechanism for moving an upper roller of the registration roller pair;

FIG. 4 is a front view showing a registration roller pair representative of an alternative embodiment of the present invention; and

FIG. 5 is a front view showing a registration roller pair representative of another alternative embodiment of the present invention.

### DESCRIPTION OF THE PREFERRED EMBODIMENTS

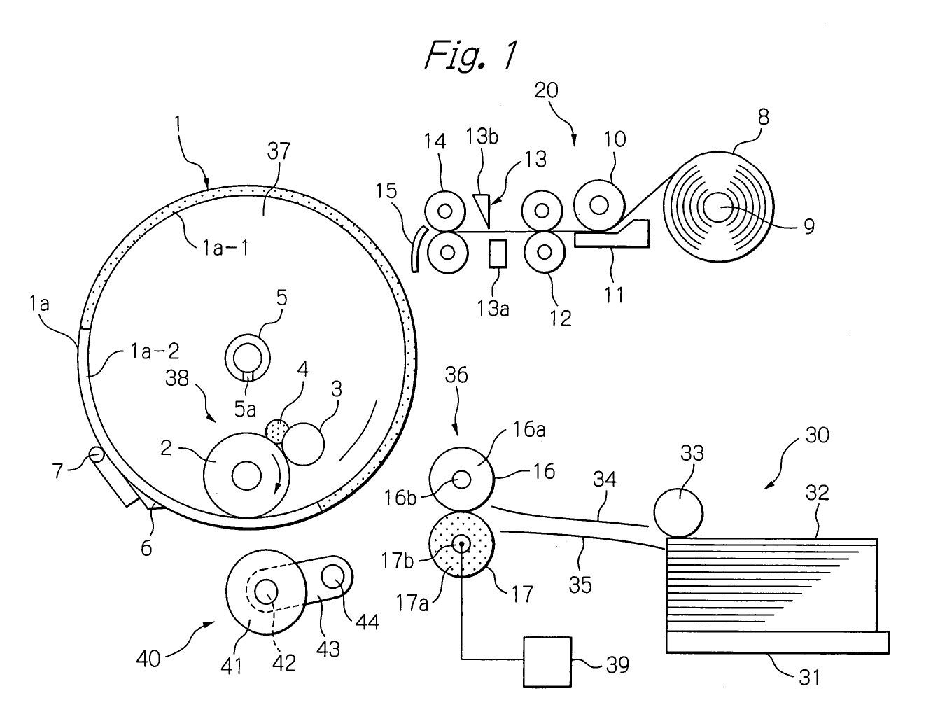

Referring to FIGS. 1 through 3, a stencil printer embodying the present invention is shown. First, reference will be made to FIG. 1 for describing the construction and operation of the illustrative embodiment. As shown, the stencil printer includes a print drum 1 located at substantially the center of a printer body, not shown, and a master making device 20 positioned above the print drum 1 at the right-hand side. A sheet feeding device or recording medium feeding means 30 is positioned below the master making device 20 while a registration roller pair 36 is positioned downstream of the sheet feeding device 30 in the direction of sheet feed. Pressing means 40 is positioned below the print drum 1 and constitutes a pressing portion in cooperation with the print drum 1.

More specifically, the master making device 20 includes a stencil 8 implemented as a roll wrapped around a core 9, which is rotatably supported by holder members not shown, such that the stencil 8 can be paid out from the roll. A platen roller 10 is positioned downstream of the stencil roll in the direction of stencil conveyance and rotatably supported by side walls, not shown, included in the master making device 20. A thermal head 11, including numerous heating devices, is pressed against the platen roller 10 by biasing means not shown. A stepping motor, not shown, causes the platen roller 10 to rotate clockwise, as viewed in FIG. 1, paying out the stencil 8 from the stencil roll.

A roller pair 12 for conveyance is positioned downstream of the platen roller 10 in the direction of stencil conveyance and rotatably supported by the side walls of the master making device 20. The roller pair 12 is rotated at slightly higher speed than the platen roller 10 so as to apply preselected tension to the stencil 8 while slightly slipping on the stencil 8.

A guillotine type of cutter 13 is located downstream of the roller pair 12 for cutting the perforated portion of the stencil 8 at a suitable length. While the guillotine type of cutter 13 has an upper and a lower edge 13a and 13b, it may be replaced with, e.g., a rotary edge type of cutter, if desired.

A turn roller pair or master feed roller pair 14 is located downstream of the cutter 13 and rotatably supported by the side walls of the master making device 20 while being pressed against each other. The turn roller pair 14, like the roller pair 14, exerts adequate tension on the stencil 8 while slipping on the stencil 8.

A guide plate 15 is positioned downstream of the turn roller pair 14 and so curved as to guide the leading edge of the perforated stencil 8 toward a clamper, which will be described later, mounted on the print drum 1.

The print drum 1 includes a rotatable shaft 5 playing the role of an ink feed pipe at the same time. Two flanges 37 are affixed to the shaft 5 at positions spaced in the axial direction of the shaft 5. A porous support, implemented as a hollow cylinder, la is affixed to the circumferential edges of the flanges 37 at opposite ends. A laminate of mesh screens, not shown, covers the outer periphery of the porous support 1a and is formed of resin or implemented as wire nets. A drive force is transmitted to the print drum 1 via a gearing or similar drive transmitting means, not shown, causing the print drum 1 to rotate clockwise, as viewed in FIG. 1.

The print drum 1 has a porous portion 1a-1 and a non-porous portion 1a-2. A stage 6, formed of a magnetic material, is mounted on the surface of the non-porous portion 1a-2 and extends in the axial direction of the drum 1. A clamper 7 is also mounted on the surface of the nonporous portion 1a-2 in parallel to the stage 6 and magnetically adheres to the stage 6. An opening/closing device, not shown, causes the damper 7 to open and close at a preselected position.

Ink feeding means 38 is arranged inside of the print drum 1 and includes the shaft or ink feed pipe 5 mentioned earlier, an ink roller 2 journalled to side walls, not shown, affixed to the shaft 5, and a doctor roller 3 also journalled to the above side walls and spaced from the ink roller 2 by a small gap. The ink roller 2 is caused to rotate in synchronism with and in the same direction as the print drum 1 via a gearing, belt or similar drive transmitting means not shown. The ink roller 2 and doctor roller 3 form a generally wedge-shaped space therebetween that serves as an ink well 4.

An ink feeding device, not shown, feeds ink from an ink pack, not shown, located outside of the print drum 1 to the ink feed pipe 5. The ink reached the ink feed pipe 5 drops via apertures 5a formed in the pipe 5 into the ink well 4 and then deposits on the ink roller 2 in the form of a thin layer while being metered by the doctor roller 3. The print drum 1, ink pack and so forth are constructed into a single unit in the axial direction of the print drum 1. This unit is removably mounted to the printer body.

The sheet feeding means 30 includes an elevatable tray 31 loaded with a stack of sheets or recording media 32 and a pickup roller 33 configured to pay out the top sheet 32 from the tray 31 in cooperating with a separating member not shown. The sheet 32 thus paid out from the tray 31 is conveyed to the registration roller pair 36 via an upper and a lower guide 34 and 35.

The registration roller pair 36 is made up of a lower registration roller 17 journalled to the side walls of the printer body and an upper registration roller 16 rotatably supported by registration arms, which will be described later. A stepping motor 39 is drivably connected to the lower registration roller 17 by a belt or gears. Control means, not shown, causes the lower registration roller 17 to rotate counterclockwise, as viewed in FIG. 1, via the stepping motor 39, so that the registration rollers 17 and 16 nip and convey the sheet 32 at a speed matching with the peripheral speed of the print drum 1.

The pressing means 40 mentioned previously includes a shaft 44 journal led to the side walls of the printer body, a pair of press roller arms 43 (only one is visible) affixed to the shaft 44, and a press roller 41 rotatably supported by the press roller arms 43 via a shaft 42. A cam, for example, causes the press roller 41 to selectively move into or out of contact with the print drum 1 while a spring member, not shown, constantly biases the press roller 41 toward the print drum 1. Locking means, not shown, locks the press roller 41 in a position spaced from the print drum 1 except when the sheet 32 is conveyed.

A peeler, not shown, is positioned at the left-hand side of the print drum 1 and adjoins the print drum 1 to peel the sheet 32 off the surface of the print drum 1. Sheet conveying means, not shown, is located below the peeler in order to convey the sheet 32 thus peeled off to a print tray not shown. Further, a master discharging device, not shown, is arranged above the print drum 1 at the left-hand side for peeling a used master off the outer periphery of the print drum 1.

In operation, the operator of the stencil printer sets a desired document on a document scanning section, not shown, and then presses, e.g., a start button positioned on an operation panel not shown. In response, the print drum 1 is rotated by a driving device, not shown, while a used master wrapped around the print drum 1 is removed and then discarded by the master discharging device.

After the used master has been discharged, the print drum 1 is rotated to a position where the damper 7 faces substantially sideways at the right-hand side and then stopped. At this position, the damper 7 is opened by the opening/closing means and waits for a master. As soon as the damper 7 is opened, a current, implemented as pulses, is selectively fed to the heating devices of the thermal head 11 in accordance with image data output from the document scanning section, thereby selectively perforating the stencil 8 with heat.

Assume that the leading edge of the stencil 8 is determined to have arrived at a preselected position between the stage 6 and the clamper 7 via the guide plate 15, as determined in terms of the number of steps of the stepping motor assigned to the platen roller 10. Then, the damper 7 is closed by the opening/closing device to clamp the leading edge of the stencil 8. At the same time, the print drum 1 is again rotated at a speed substantially equal to the master making speed with the result that the perforated stencil 8 is wrapped around the print drum 1.

When the master making operation and the conveyance of the stencil 8 by a preselected length complete, as determined in terms of the number of steps of the stepping motor, the platen roller 10, roller pair 12 and turn roller pair 14 are caused to stop rotating. At the same time, the cutter 13 is operated to cut the stencil 8 at a preselected length to thereby produce a single master also labeled 8. The master 8 is then wrapped around the print drum 1 by being pulled out by the print drum 1 in rotation.

After the entire master 8 has been wrapped around the print drum 1, the sheet feeding device 30 feeds a single sheet 32 from the tray 31 toward the registration roller pair 36. The sheet 32 is brought to a stop on abutting against the nip between the upper and lower registration rollers 16a and 17a, which are pressed against each other. Subsequently, the stepping motor 39 is energized in accordance with information output from, e.g., a sensor, not shown, responsive to the position of the print drum 1, causing the registration roller pair 36 to convey the sheet 32 toward a pint position between the print drum 1 and the press roller 41 while accelerating the sheet 32 little by little.

In response to the output of a sensor, not shown, responsive to the sheet 32, the locking mans is operated to unlock the press roller 41. As a result, the press roller 41 is brought into contact with the print drum 1 with the intermediary of the sheet 32 by the action of the spring member, causing the master 8 to closely adhere to the print drum 1.

Subsequently, the upper registration roller 16 is released from the lower registration roller 17 at a preselected position, so that the sheet 32 is conveyed by the print drum 1 and press roller 41. The peeler, adjoining the print drum 1, peels the sheet 32 being conveyed by the print drum 1 and press roller 41 off the print drum 1. Thereafter, the sheet conveying means conveys the sheet 32 to the print tray.

After the procedure described above, the press roller 41 and other constituents of the stencil printer each are returned to the initial position. In this condition, the stencil printer remains in a stand-by state. Subsequently, a desired number of sheets 32 are continuously fed, subject to actual printing, and then sequentially stacked on the print tray.

After all the sheets or simplex prints 32 have been stacked on the print tray, the operator picks up the stack, reverses the stack, and then sets it on the tray 31 of the sheet feeding device 30. Subsequently, the operator sets another document to be printed on the other surfaces of the simplex prints on the document reading section, and then presses, e.g., the start button mentioned earlier. In response, a new master 8 is wrapped around the print drum 1 by the procedure stated previously.

After the new master 8 has been fully wrapped around the print drum 1, the sheets or simplex prints 32 are sequentially fed from the tray 31 to the registration roller pair 36 one by one. This is also followed by the conveyance of the sheet 32 to the print position between the print drum 1 and the press roller 41 via the registration roller pair 36. At this instant, although the surface of the sheet 32 carrying an ink image thereon contacts the lower registration roller 17, the retransfer of the ink from the above surface to the lower registration roller 17 and therefore the offset of the next sheet 32 is obviated for reasons to be described specifically later. In this manner, ink images are printed on the other surfaces of the simplex prints 32, completing duplex prints.

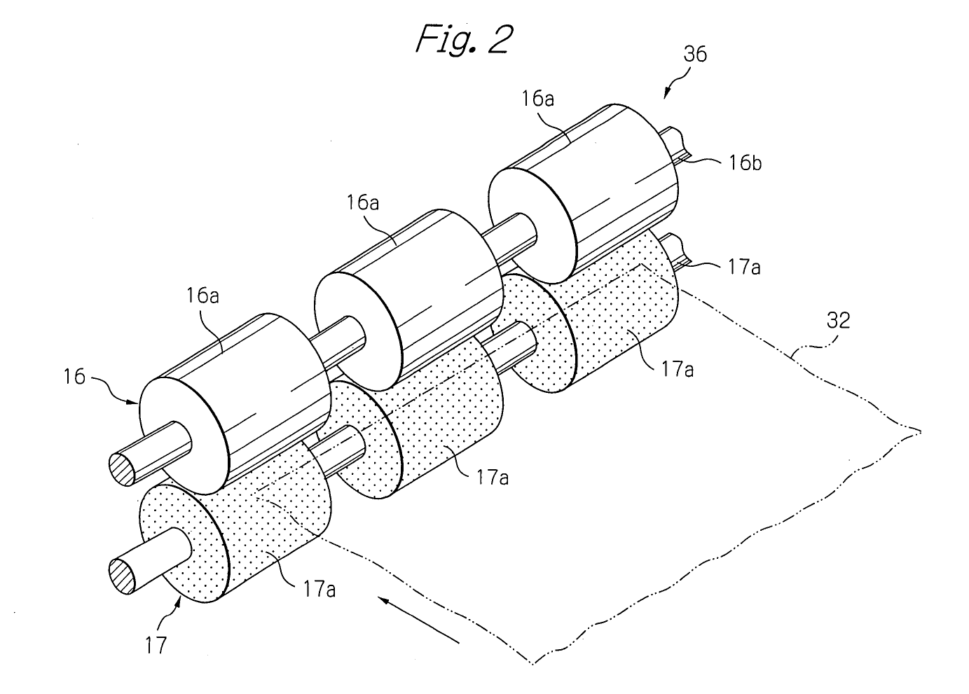

FIG. 2 shows the configuration of the registration roller pair 36 in detail. As shown, the upper registration roller 16 is made up of a shaft 16b and a plurality of roller portions 16b arranged on the shaft 16 at preselected intervals in the axial direction of the shaft 16b. Likewise, the lower registration roller 17 is made up of a shaft 17b and a plurality of roller portions 17a arranged on the shaft 17b at preselected intervals in the axial direction of the shaft 17b.

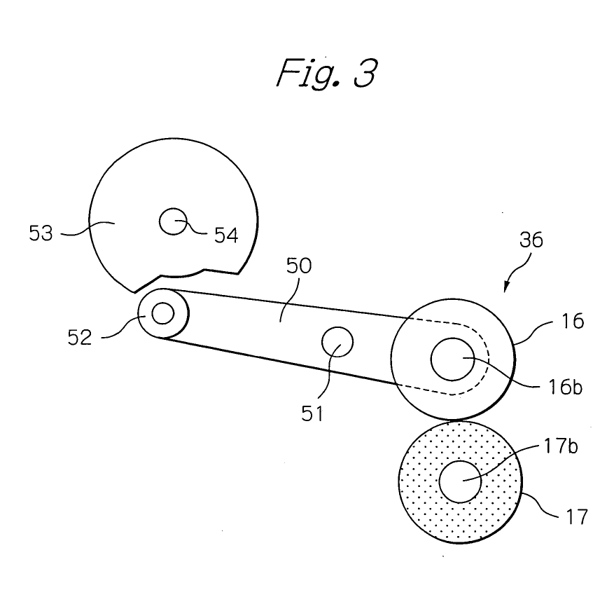

As shown in FIG. 3, a registration arm pair 50 is affixed to a shaft 51 journalled to the side walls of the printer body. The shaft 16b of the upper registration roller 16 is rotatably supported by the registration arm pair 50 at opposite ends. A cam follower 52 is rotatably mounted on one end of the registration arm pair 50 and held in contact with a registration cam 53, which is rotatable about a shaft 54 in synchronism with the print drum 1. The registration cam 53 in rotation causes the registration arm pair 50 to swing about the shaft 51 via the cam follower 52 such that the upper registration roller 16 is selectively brought into or out of contact with the lower registration roller 17 at a preselected position. More specifically, the upper registration roller 16 is caused to contact the lower registration roller 17 at preselected timing and then parts from the same after the conveyance at a preselected position so as not to constitute a load.

In the illustrative embodiment, the roller portions 16a of the upper registration roller 16 are formed of polyacetal resin. Fine projections and recesses with a size of several microns to several ten microns are formed on the surface of each roller portion 16a by integral molding, etching or similar technology. On the other hand, the roller portions 17a of the lower registration roller 17, which contacts the image surface of each simplex print 32, are formed of highly oil-repellent fluororubber.

The image surface of the simplex print 32 is strongly pressed against the lower registration roller 17 while being conveyed by the registration roller pair 36. However, fluororubber, constituting the roller portions 17a of the lower registration roller 17, allows a minimum of ink to deposit on the surface of the roller 17, more precisely the surfaces of the roller portions 17a. This successfully prevents the ink from being retransferred from the simplex print 32 to the lower registration roller 17 and stored therein and therefore obviates the offset of the next and successive sheets.

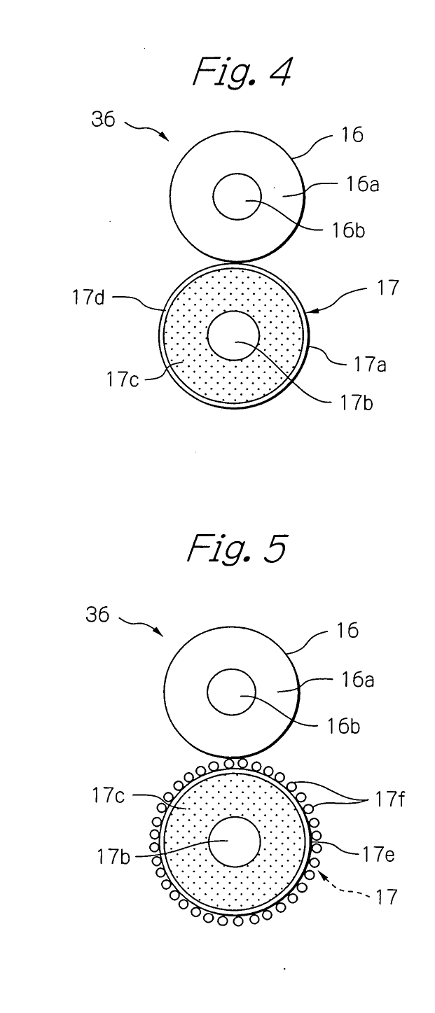

FIG. 4 shows an alternative embodiment of the present invention. In FIG. 4, structural elements identical with the structural elements of the previous embodiment are designated by identical reference numerals and will not be described specifically in order to avoid redundancy. This is also true with another embodiment to be described later.

In the illustrative embodiment, the roller portions 17a of the lower registration roller 17 are not simply formed of fluororubber. More specifically, as shown in FIG. 4, the roller portions 17a each are made up of a base 17c formed of chloroprene rubber or similar ordinary material and a thin fluororubber layer 17d formed on the outer periphery of the base 17c by coating. The fluororubber layer 17d can sufficiently repel ink alone.

FIG. 5 shows another alternative embodiment of the present invention. Briefly, this embodiment is characterized in that fine oil-repellent grains are positioned on the surfaces of the roller portions 17a included in the lower registration roller 17.

More specifically, as shown in FIG. 5, each roller portion 17a of the lower registration roller 17 includes a smooth sheet 17e covering the surface of the base 17c, which is formed of chloroprene rubber or similar ordinary material. Glass beads 17f, which are a specific form of fine oil-repellent grains, are affixed to the surface of the smooth sheet 17e by adhesive. The glass beads 17f provide the roller portions 17a with a highly oil-repellent surface configuration as in the previous embodiments.

If desired, for the sheet 17e and glass beads 17f, use may be made of a commercially available, glass beads sheet with the glass beads 17f affixed thereto beforehand, in which case the glass beads sheet will be adhered to the surface of the base 17c. Further, the glass beads 17e may be directly adhered to the surface of the base 17c in order to implement the highly oil-repellent surface configuration.

In the illustrative embodiments shown and described, one roller of the registration roller pair 36 is provided with the highly oil-repellent surface configuration. When a conveying member expected to contact the image surface of the simplex print 32 first is located upstream of the registration roller pair 36, the oil-repellent surface configuration may, of course, be applied to such a conveying member.

In summary, it will be seen that the present invention provides a stencil printer having various unprecedented advantages, as enumerated below.

(1) In a duplex print mode, the retransfer of ink from the image surface of a simplex print to a conveying member, e.g., one roller of a registration roller pair is reduced, so that offset of the next and successive simplex prints ascribable to the conveying member is obviated. This enhances efficient printing operation.

(2) A fluororubber layer, formed on one roller of the registration roller pair that contacts the image surface of the simplex print, allows the inside of the roller to be formed of an inexpensive elastic material, thereby realizing desirable oil-repellence at low cost.

(3) Glass beads or similar fine oil-repellent grains are provided on the surface of the roller expected to contact the image surface of the simplex print, easily implementing a highly oil-repellent configuration. This is also true when a sheet with such grains adhered thereto is adhered to the surface of the roller.

Various modifications will become possible for those skilled in the art after receiving the teachings of the present disclosure without departing from the scope thereof.

What is claimed is:

1. A stencil printer comprising:
a print drum comprising a porous hollow cylinder rotatably supported and configured such that a perforated stencil is wrapped around an outer periphery of said print drum;
pressing means for forming a pressing portion when pressed against said print drum;
feeding means for feeding a sheet-like recording medium toward said pressing portion; and
a plurality of conveying members configured to convey the recording medium;
wherein one of said conveying members expected to contact, when the recording medium carrying an image on one surface thereof is reversed and again fed by said feeding means, said one surface first is provided with a highly oil-repellent surface configuration.

2. The printer as claimed in claim 1, wherein the one conveying member comprises a registration roller pair configured to convey the recording medium toward said pressing portion at preselected timing.

3. The printer as claimed in claim 2, wherein the one roller of the registration roller pair expected to contact the image surface of the recording medium is formed of fluororubber.

4. The printer as claimed in claim 2, wherein a fluororubber layer is formed on a surface of the one roller of the registration roller pair expected to contact the image surface of the recording medium.

5. The printer as claimed in claim 2, wherein fine oil-repellent grains are positioned on a surface of the one roller of the registration roller pair expected to contact the image surface of the recording medium.

6. The printer as claimed in claim 5, wherein said fine oil-repellent grains comprise glass beads.

7. The printer as claimed in claim 5, wherein a sheet, holding said fine oil-repellent grains integrally therewith, is adhered to the surface of the one roller.

8. A stencil printer comprising:
a print drum comprising a porous hollow cylinder rotatably supported and configured such that a perforated stencil is wrapped around an outer periphery of said print drum;
pressing means for forming a pressing portion when pressed against said print drum;
feeding means for feeding a sheet-like recording medium toward said pressing portion; and
a registration roller pair configured to convey the recording medium toward said pressing portion at preselected timing;
wherein one roller of said registration roller pair expected to contact, when the recording medium carrying an image on one surface thereof is reversed and again fed by said feeding means, said one surface first is provided with a highly oil-repellent surface configuration.

9. The printer as claimed in claim 8, wherein the one roller of the registration roller pair expected to contact the image surface of the recording medium is formed of fluororubber.

10. The printer as claimed in claim 8, wherein a fluororubber layer is formed on a surface of the one roller of the registration roller pair expected to contact the image surface of the recording medium.

11. The printer as claimed in claim 8, wherein fine oil-repellent grains are positioned on a surface of the one roller of the registration roller pair expected to contact the image surface of the recording medium.

12. The printer as claimed in claim 11, wherein said fine oil-repellent grains comprise glass beads.

13. The printer as claimed in claim 11, wherein a sheet, holding said fine oil-repellent grains integrally therewith, is adhered to the surface of the one roller.
